(19) United States
(12) Patent Application Publication
(10) Pub. No.: US 2001/0050989 A1
(43) Pub. Date: Dec. 13, 2001

(54) Systems and methods for implementing encryption algorithms

(76) Inventor: Jabari Zakiya, Hyattsville, MD (US)

Correspondence Address: Jabari Zakiya, 4506 South Dakota Ave NE, Washington, DC, 20017, US

(21) Appl. No.: 09/875,437

(22) Filed: Jun. 7, 2001

Related U.S. Application Data
(60) Provisional application No. 60/209,770, filed on Jun. 7, 2000.
(60) Provisional application No. 60/209,772, filed on Jun. 7, 2000.
(60) Provisional application No. 60/216,634, filed on Jul. 7, 2000.

(51) Int. Cl. H04L 9/06

(52) U.S. Cl. 380/29; 380/37

(57) ABSTRACT

The present invention describes a method for implementing block encryption algorithms completely as non-sequential devices and systems. The method allows for encryption algorithms, using constant, or variable, key sizes, to be performed in one process (clock) cycle instead of the multiple cycles sequential designs require. This enables encryption devices and systems to operate significantly faster, and more simply, than sequential implementations. Thus, this invention allows encryption algorithms to be effectively performed as non-sequential logic gate functions.

This application claims the benefit of Provisional Application 60/209,770 of Jabari Zakiya filed Jun. 7, 2000 for METHOD FOR IMPLEMENTING THE RC6 ENCRYPTION ALGORITHM AS A HARDWARE LOGIC GATE, and of Provisional Application 60/209,772 of Jabari Zakiya filed Jun. 7, 2000 for METHOD FOR IMPLEMENTING THE TOWFISH ENCRYPTION ALGORITHM AS A HARDWARE LOGIC GATE, and of Provisional Application 60/216,634 of Jabari Zakiya filed Jul. 7, 2000 for METHOD FOR IMPLEMENTING THE SERPENT ENCRYPTION ALGORITHM AS A HARDWARE LOGIC GATE, the contents of which are incorporated herein.

### FIELD OF INVENTION

This invention relates to the field of cryptography, data encryption, digital hardware systems, and more particularly, systems and devices for implementing encryption algorithms in hardware.

### BACKGROUND OF THE INVENTION

Data encryption has become increasingly important, and even required, in an expanding array of applications. No longer strictly used by the military and government, commercial applications of encryption have become the driving force behind the hardware implementation of encryption algorithms. These commercial applications encompass the wireless market, Internet protocols, banking and financial systems, email and data storage, and more.

Hardware implementations of encryption algorithms are necessary to meet the increasing data rates for many of these systems. Hardware encryption also provides standard implementations of algorithms and higher security against tampering, versus software implementations. They also reduce the processing requirements placed on system processors.

Current hardware implementations of encryption algorithms generally perform the sequential software description of the algorithms. They, generally, perform the cipher arithmetic operations as one core function, which is then clocked, in a feedback mode, which uses the output of one “round” as the input to the next. They also perform key processing in various ways, to supply the cipher core function the correct key dependent data for each round.

This invention describes a method for implementing encryption algorithms as non-sequential systems. This includes not only the cipher operations of an algorithm, but the key processing too. Thus, this invention describes a method for implementing encryption algorithms that will encipher and decipher an input block of data, with a given key, in one process (clock) cycle.

A consequence of this invention's design philosophy is that it is better to trade off hardware resources (gates) for clock cycles (time). This enables algorithms to be implemented architecturally in the fastest manner possible. This creates many advantages over sequential devices. First, all external clocking circuitry is eliminated, making systems easier to design, which use less parts. Thus, boards can be made smaller, which use less power and produce less heat, which increases their reliability, resulting in significant reductions in total system costs.

Even more importantly, this invention allows encryption algorithms to easily meet the performance requirements of new Internet broadband rates, cell phones, and other highspeed usages. This will become increasingly more important as security protocols such as SSL and IPSEC are implemented over faster networks. Where systems previously had milliseconds to process unencrypted data packets, these new environments will require multiple layers of encryption and authentication to be performed on each data packet in less time.

The invention allows encryption systems to be simply characterized using HDLs, for easy implementation in device, and system-on-chip (SOC), designs. And as fab processes become denser and faster, systems will be more cost effective to produce, and preferable, than with other methods.

### OBJECTS OF THE INVENTION

It is an object of the present invention to create devices and systems to perform encryption algorithms using only combinatorial non-sequential logic.

Another object of the invention is to perform encryption algorithms architecturally in the fastest manner.

Still another object of the invention is to create encryption devices and systems which eliminate the need for external clocking circuitry.

A further object of the invention is to minimize a system's complexity and parts counts to perform encryption in hardware.

Yet another object of the invention is to create the lowest power consuming and heat dissipating encryption devices and systems.

Still yet another object of the invention is to maximize an encryption system's reliability.

Another object of the invention is to minimize total system costs to perform encryption.

Still a further object of the invention is to allow encryption designs to be easily configurable in systems for any mode of operation (ECB, CBC, CFB, OFB).

Still another object of this invention is to produce simple HDL device models which can implement an encryption algorithm in FPGA, ASIC, and VLSI designs, using various device technologies.

### SUMMARY OF THE INVENTION

It is therefore an object of the present invention to perform encryption algorithms as devices or systems comprised totally of non-sequential combinatorial logic. The above and other objects of the invention are achieved through the creation of a non-sequential decomposition of an encryption algorithm. This decomposition creates embodiments of combinatorial logic elements which are simply connected together to perform a total encryption algorithm.

This invention makes use of a design philosophy, and techniques, to take full advantage of modern device technologies. These design techniques make full and optimum use of the large gate resources and routing capabilities of modem FPGA, ASIC, and VLSI devices. This enables this invention to create architectures for performing encryption algorithms in the fastest manner possible. Thus, the present invention represents a significant advancement in the state-of-the-art of design philosophy, applied to the implementation of encryption algorithms.

### BRIEF DESCRIPTION OF THE DRAWINGS

The objects, features, and advantages of the present invention will be apparent from the following detailed description of the preferred embodiments of the invention with references to the following drawings.

FIG. 1 is a block diagram of the Twofish cipher algorithm.

FIG. 2 is a block diagram of two methods for implementing Twofish as a Feistel network.

FIG. 3 is a block diagram of a Twofish round implemented as a Feistel network.

FIG. 4 is a flow diagram of the standard mode Serpent encipher and decipher algorithm.

FIG. 5 is a block diagram of the Serpent encipher core logic function in bitslice mode.

FIG. 6 is a block diagram of the Serpent decipher core logic function in bitslice mode.

FIG. 7 is a flow diagram of the RC6 encryption algorithm.

FIG. 8 is a flow diagram of the RC6 decryption algorithm.

FIG. 9 is a functional block diagram of an RC6 encryption round.

FIG. 10 is a functional block diagram of an RC6 decryption round.

FIG. 11 is a finctional block diagram of an RC6 round implemented as a Feistel network.

FIG. 12 is a block diagram for Serpent implemented as a device-level Feistel-like network.

FIG. 13 is a block diagram of RC6 implemented as a Feistel network.

FIG. 14 is a block diagram of Twofish implemented as a Feistel network.

### DETAILED DESCRIPTION

Decomposing Block Ciphers

Block encryption algorithms operate on a fixed bit size input block of data to produce an enciphered or deciphered fixed bit size output block. A fixed bit size “key” is used to create a unique “ciphertext” representation for an enciphered input “plaintext” block. The same key is used to recover the plaintext from the ciphertext by using an inverse deciphering algorithm.

Block ciphers typically have the generic structure b[i+1]=Cg(b[i], k[i]), for i=0 . . . N−1, where b[i+1] is the output block generated for the ith round by cipher function Cg, which processes an input block b[i] and a key dependent data component k[i]. N rounds of function Cg are performed to produce the final ciphered output data block.

Cipher function Cg is a generic function which performs the arithmetic, and other, operations necessary to perform a given cipher algorithm. It can be demonstrated that the Cg function can be implemented as a Feistel-like network if the cipher structure of an algorithm isn't inherently a Feistel network, or, separate encipher and decipher functions can be created, which can be used to form a Feistel-like structure at a higher system level. Feistel, or Feistel-like structures are generally desirable, as they allow an algorithm to perform both enciphering and deciphering with one generic round structure, which can simplify its design and implementation. It can also be shown that Cg can be structured to accommodate the use of variable key sizes if necessary.

This invention also performs key processing non-sequentially, which will accommodate the use of variable fixed key sizes, such as those stipulated for the Advanced Encryption Standard (AES) of 128, 192 and 256 bits. Depending on the cipher algorithm, key processing can be structured to create expanded or subkey data, which becomes stable either after a constant total propagation delay (tpd) for all usable key sizes, or after increasing tpds for increasing key sizes. Key processing can also be structured to provide the Cg functions the correct key dependent data when used in Feistel or Feistel-like network, for single or variable key size systems.

The full implementation of an algorithm's cipher structure consists of stringing separate instances of the Cg functions together, with the output of one function routed into the input of the next, for the necessary number of round instances. A key processing subsystem processes the input key to produce expanded or subkey data. This data is then routed to the Cgs, either directly, or through a multiplexing subsystem to accommodate Feistel or Feistel-like system architectures.

The performance of a block cipher will be determined by the critical delay path for a given configuration, which is normally the input block-to-output block delay path. The critical delay path tpd determines how long the input data must be held stable in order to produce stable output data. Likewise, the key dependent data must be held constant for this time period too.

### Decomposing Example Algorithms

There are certain basic operations algorithms perform that have simple hardware decompositions. All fixed bit rotations and shift operations are merely new mappings/routing of data. All constant 2ⁿ multiplications/divisions are merely fixed bit shifts. Addition and subtraction can be performed with the same logic element and a control line. Conditional algorithmic switching is done with multiplexing networks or routing tables. The creation of conditional flags can be achieved with XOR, AND, or other simple logic operations, using control signals and/or data. The repetitive use of a function is achieved by multiple instantiations of the function. Constants data values can be directly embedded into functions without requiring storage elements.

Using these techniques, and others, it will be demonstrated how existing block ciphers are decomposed to be implemented as non-sequential systems or devices. The different characteristics of the example algorithms provide a good basis to show how the decomposition process applies to dissimilar cipher structures and implementation requirements.

The block ciphers chosen to illustrate this process are three of the five final AES candidate algorithms, namely Twofish, RC6, and Serpent. Their input and output block sizes are 128-bits, and their input key sizes can be 128, 192, or 256 bits. Twofish was designed to be inherently implemented as a Feistel network at the round level. RC6 was not inherently designed to be a Feistel network, but it can be transformed into one at the round level. Serpent is inherently an asymmetric algorithm, requiring different cipher structures at the round level. N (the number of rounds for each algorithm) is 16 for Twofish, 20 for RC6, and 32 for Serpent, for all key sizes.

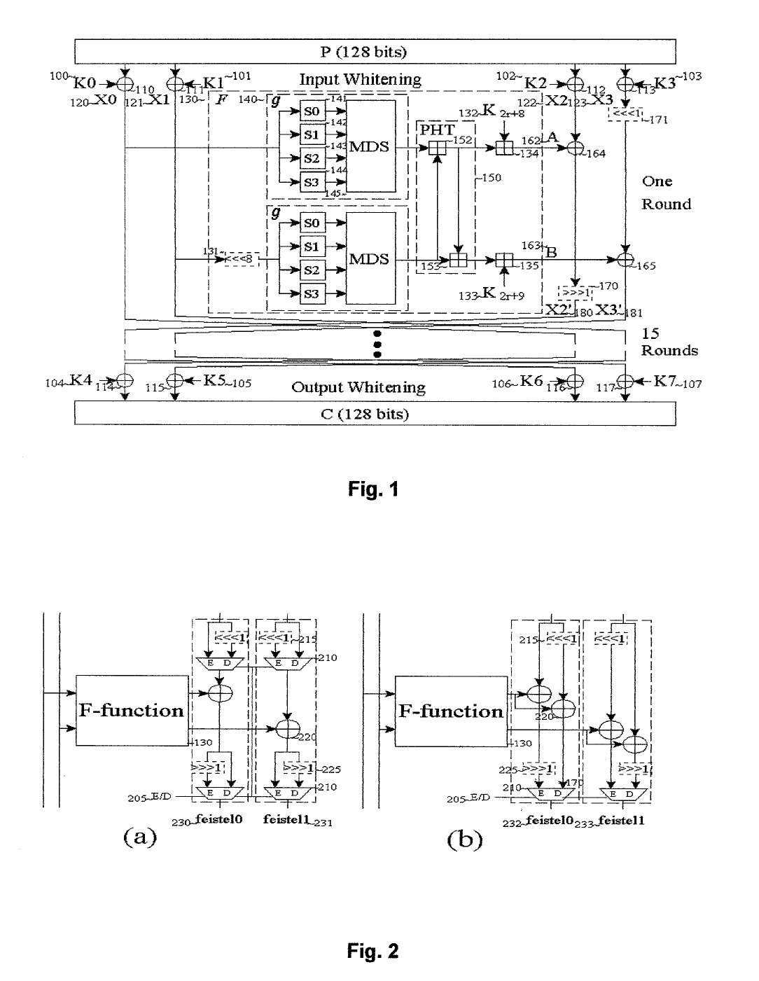

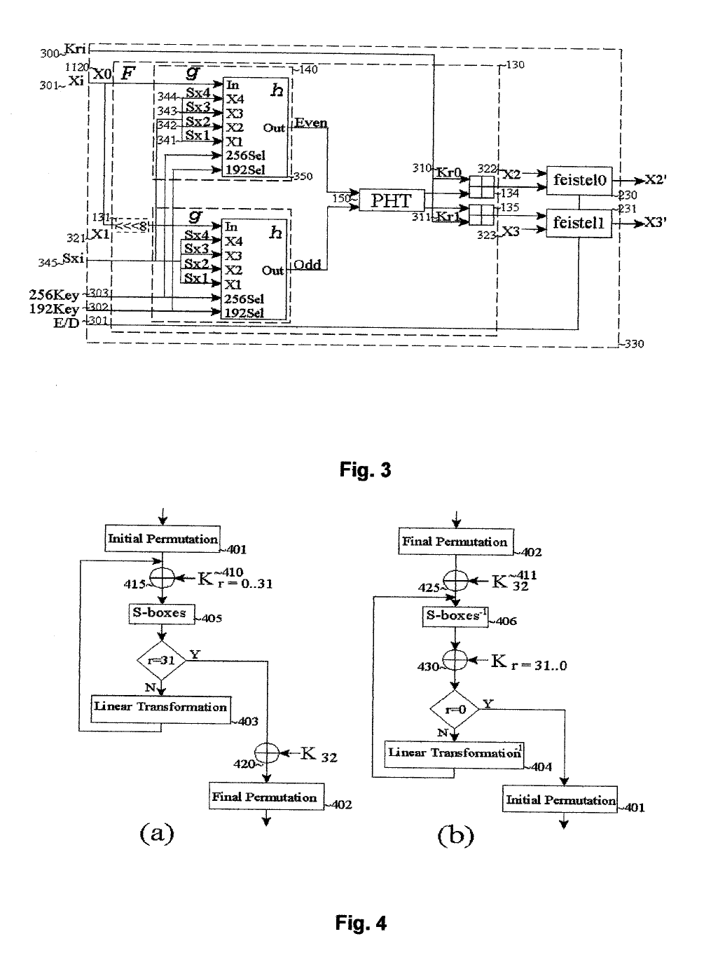

FIG. 1 shows a block diagram of the Twofish encipher architecture. The decipher structure differs by only a pair of fixed 1-bit rotations. FIG. 2 shows two ways the rotations can be structured to create a Feistel network, using XORs 220, and mux elements 210 for data routing switching based on the cipher mode. FIG. 3 show the generic round function Cg for Twofish as a Feistel network.

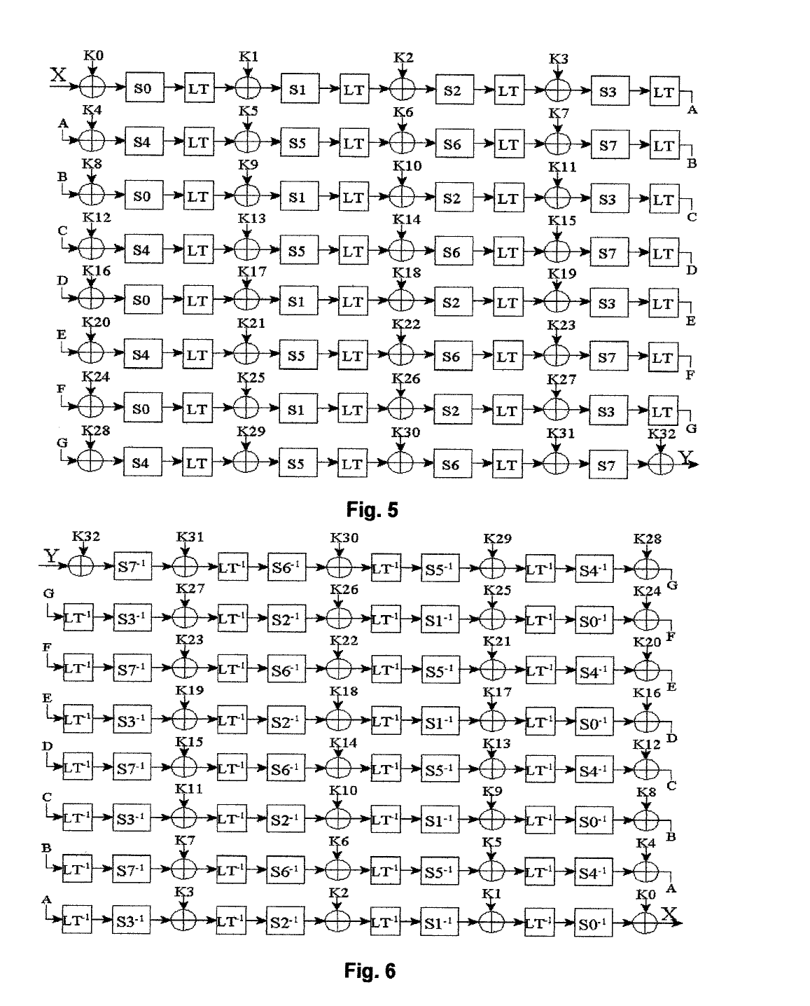

Unlike Twofish, Serpent's encipher structure 4(a) and decipher structure 4(b) does not allow it to be implemented as a Feistel network at the round level. Because Serpent uses different S-boxes 405/6 and linear transforms 403/4 to encipher and decipher, there can be no sharing of operational components. FIG. 5 and FIG. 6 show the different asymmetric structures for the full 32 round encipher and decipher modes.

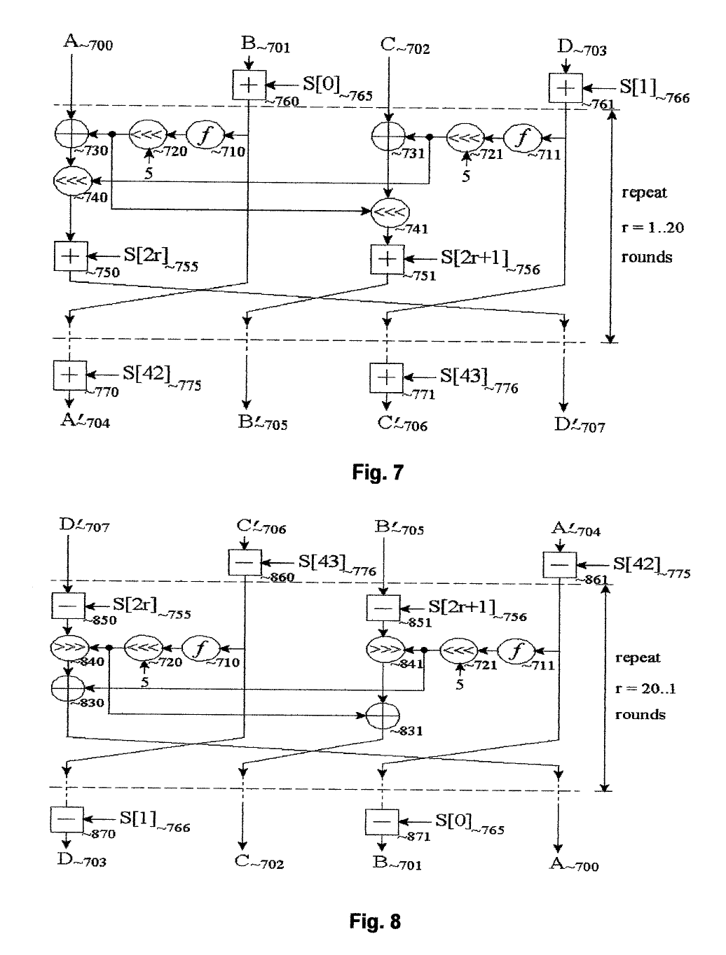

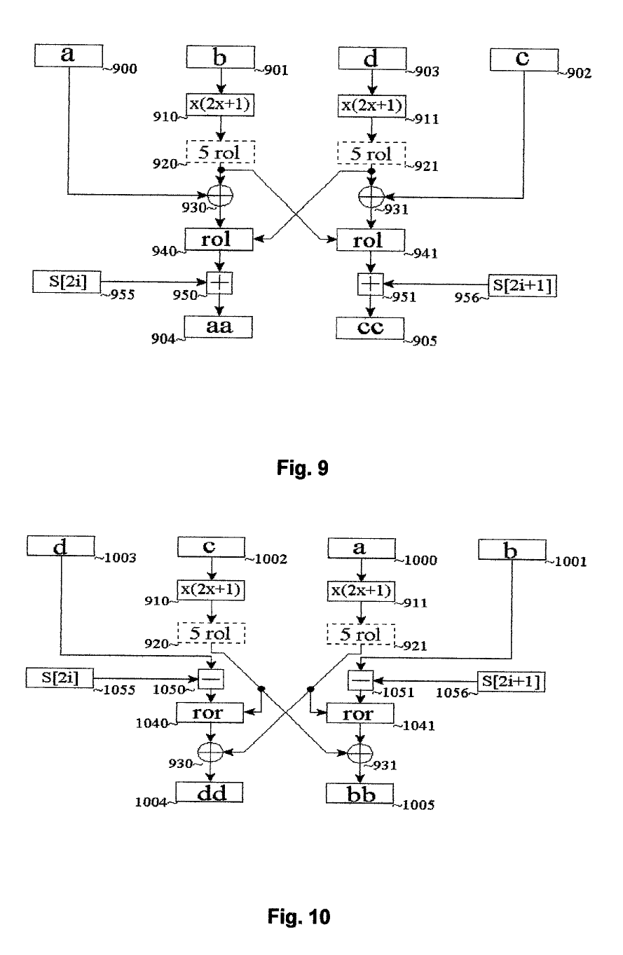

RC6 is in-between. Though not a natural Feistel network it can be transformed into a Feistel network to perform both cipher modes with one architecture. FIG. 7 shows the full 20 round encipher structure, while FIG. 8 shows the full decipher structure. FIG. 9 and FIG. 10 show the differences between the encipher and decipher round structures. These structures can be combined into a Feistel network, as shown in FIG. 11. This is possible because of the capability of the elements 1150/51 to perform both addition and subtractions, and for 1140/41 to perform variable bit left and right 32-bit rotates. This characteristic of RC6 is not obvious from its algorithm, requiring an understanding of the capabilities of hardware to recognize it

Twofish, RC6, and Serpent produce different amounts of key processed data, using different processes. Twofish's key processing is the most complex, and increases the critical delay path tpd through the round instances for increasing key sizes. RC6 and Serpent have similar key processing characteristics. They both create a constant number of subkeys for every key size, which are generated after a constant tpd. Thus, the key size doesn't alter the performance of RC6 and Serpent.

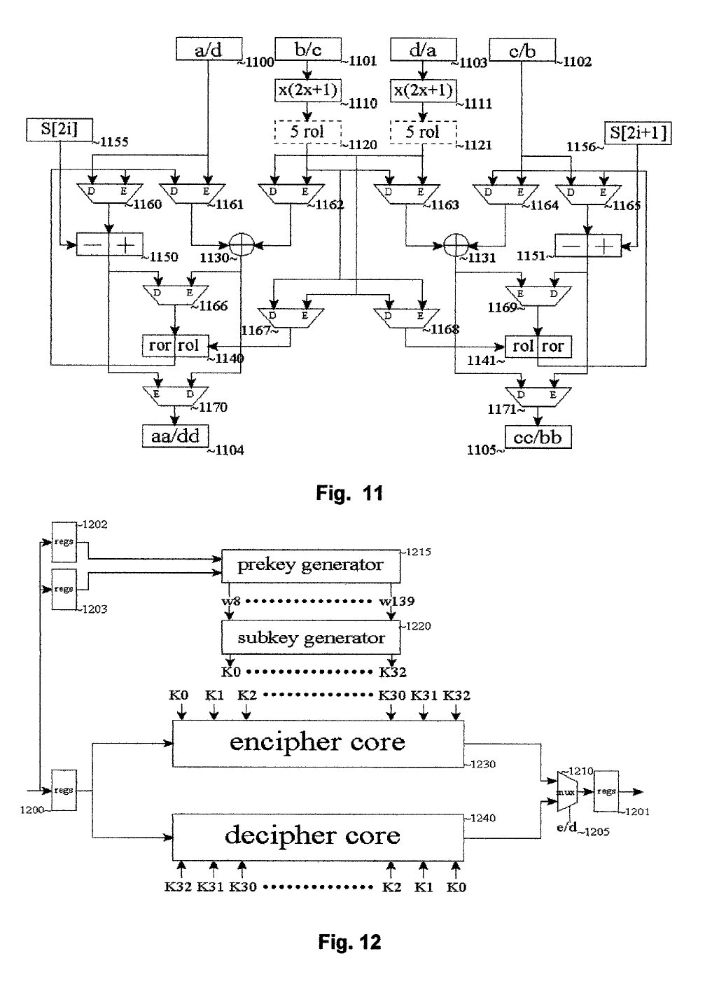

FIG. 12 shows an architecture to implement both cipher modes in one design for Serpent. Again, because the Serpent algorithm is inherently asymmetric, it can not be implemented as a Feistel network at the round level. The K0-K32 subkeys are created by 1220 once and used in ascending order in the encipher core logic 1230 and descending order in the decipher core logic 1240. A common data path is shown to feed the key and block data into the system. The logic elements l200-1203 represent storage elements (typical registers) used to hold the key and block data states constant for the required processing time. The mux element 1210 is used to rout the selected cipher data to the output data bus, as designated by the signal E/D 1205. This is about as basic and generic a high level system design will look like, which can perform both cipher modes.

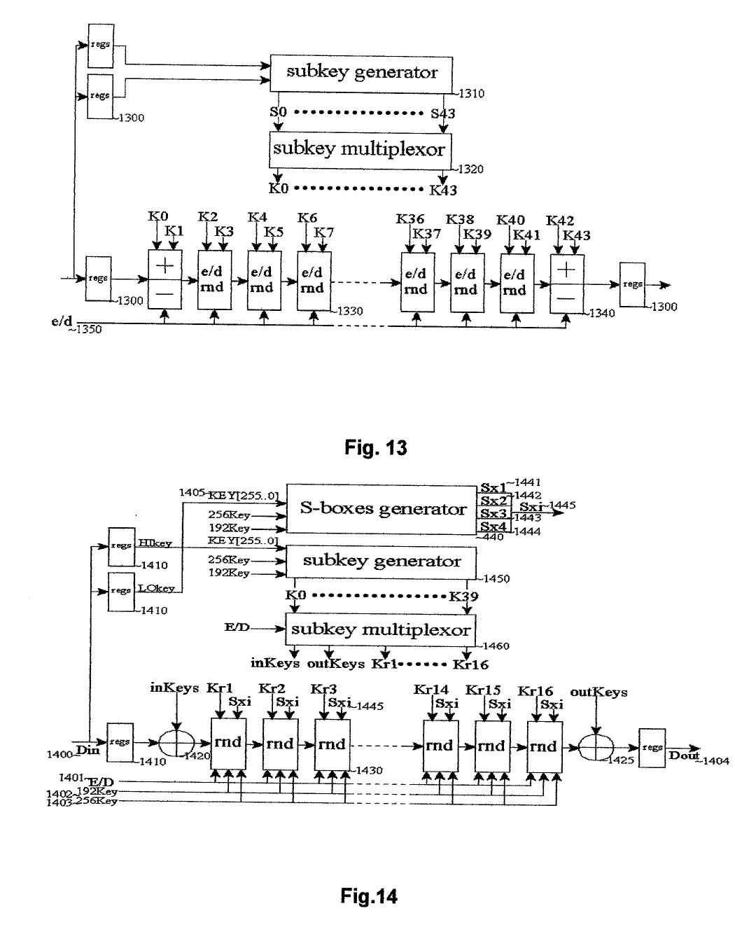

RC6, if configured as a non-Feistel network, would have virtually the same structure as shown in FIG. 12, minus prekey generator 1215. FIG. 13 shows RC6 as a classical Feistel network, with round functions 1330 implemented as Feistel structures. The 44 subkeys for RC6 are generated by 1310, but need to be routed to the round functions in ascending order to encipher, and descending order to decipher. The subkey multiplexor 1330 performs this conditional routing of K0-K43.

Twofish, which was inherently designed to have a Feistel-like round and system structure, is most efficiently configured as a Feistel network. FIG. 14 shows that Twofish has more functional elements in its structure, requiring an S-box subkey generator 1440, but minus that, it has the same generic Feistel network that RC6 has. Though the details of the Twofish algorithm demand more complex entities than RC6 or Serpent, it can be seen they all decompose into very similar architectures, which lend themselves to fairly straightforward non-sequential implementations..

Configuration and Performance Issues

The performance of a system or device is based on the propagation delay of the input block, thru the cipher logic, to the output, which normally constitutes the operational critical delay path. Some algorithms, e.g. RC6 and Serpent, have propagation delay times independent of key length. Other algorithms, e.g. Twofish, have tpds that will vary for different key sizes.

The key to increasing system or device performance (decreasing the critical delay path's tpd) is predicated on recognizing an algorithm's decompositional possibilities. Algorithms are usually written to describe their arithmetic and functional requirements, which may not be necessary (or preferable) to mimic when assessing an algorithm for decomposition into its optimum operational elements. Again, arithmetic operations, e.g. fixed bit rotations, shifts, and 2ⁿ bit multiplications and divisions, require no logic elements to perform, and are merely altered mappings, and routing, of data from one point to another.

For some applications, reductions in the throughput tpd, and gate and area usage, can be achieved for single mode implementations. Such systems include those that perform message authentication codes (MACs), which only uses an algorithm in encipher mode, as well as the transmit only end of a network, and the receive only end of a network, which requires only the decipher mode. Single mode implementations, for some algorithms, will also reduce the mux elements used for switching data routing between the modes. This is very true for an algorithm like RC6, but produces marginal implementation savings for an algorithm such as Twofish.

Determining whether an algorithm can (or should) be implemented in a Feistel network will also affect performance and gate (area) resources. For applications which require the use of both cipher modes, a Feistel-like structure is, generally, preferable to implement, as it optimizes the sharing of operational elements used in both cipher modes, which can usually be achieved to some degree.

However, the targeted implementation technology can also determine the best structure to use to generate a real system or device. Some design structures and operational elements fit better in some families of devices, versus others. This is especially true when assessing implementing a system or device using FPGAs.

Design realizability may also be an issue of consideration when considering implementing systems or devices with FPGAs. This most prevalently is a consideration for algorithms which may require a lot of memory elements, e.g. for S-boxes and lookup tables. This includes both the issues of total memory amount and memory configuration. In some instances, modeling memory arrays as multiplexor networks may be necessary, and even desirable, to get a design to fit, or perform better, for a certain family of devices.

Optimum implementations of this invention will engage in floorplanning to place operationally dependent elements as close together as possible to reduce wire and routing delay. Also, for most algorithms, the key processing logic can be implemented separately from the cipher logic. This can enable distributed systems, or system-on-chip (SOC) designs, for maximizing key processing, authentication, and storage.

It is appreciated though the present invention has been described in terms of novel and exemplary embodiments many modifications and variations might be made by those skilled in the art without departing from the spirit and scope of the invention as set forth in the following claims.

What is claimed is:

1. A system or device capable of:
taking an input block, and an input key, and generating the enciphered or deciphered output block representation of the input block, as specified by an encryption algorithm, using a non-sequential system or device architecture.

2. A system or device of claim 1 wherein:
the total propagation delay (tpd) through a critical delay path specifies the speed of a system or device.

3. A method to create a system or device of claim 1 wherein:
an encryption algorithm is decomposed into logical elements and structures to perform a plurality of operations necessary to perform the algorithm.

4. An apparatus of claim 1 wherein:
a system or device manifested in an implementing technology is the physical expression of such a system or device.
